(19) United States
(12) Patent Application Publication
(10) Pub. No.: US 2026/0020669 A1
(43) Pub. Date: Jan. 22, 2026

(54) ANGLE-ADJUSTABLE MUSIC STAND

(71) Applicant: Jianhua GUAN, Guangzhou (CN)

(72) Inventor: Jianhua GUAN, Guangzhou (CN)

(21) Appl. No.: 18/826,820

(22) Filed: Sep. 6, 2024

(30) Foreign Application Priority Data
Jul. 19, 2024 (CN) 202421730308.7

(51) Int. Cl. A47B 23/00; F16M 11/14; F16M 13/02

(52) U.S. Cl. CPC A47B 23/004; F16M 11/14; F16M 13/022

(57) ABSTRACT

The present disclosure provides a music stand, which includes a sheet music board and a support frame. The support frame includes an adjusting component with at least one degree of freedom; the sheet music board is connected to the adjusting component; the adjusting component is used to adjust the angle of the sheet music board with respect to the support frame. In some embodiments, the adjusting component includes a first accessory and a second accessory. A first end of the first accessory is rotatably connected to a first end of the second accessory.

### CROSS REFERENCE TO RELATED APPLICATIONS

This application claims priority benefits to Chinese Patent Application No. 2024217303087, filed on Jul. 19, 2024, the contents of which are incorporated herein by reference.

### TECHNICAL FIELD

The present disclosure relates to an angle-adjustable music stand.

### BACKGROUND

Sheet music is commonly used for recording music notations, such as the pitch, duration and rhythm of the music. These notations on the sheet music enables musicians to understand and grasp composers' intention, thereby playing the music accurately. Sheet music is not only a visual notation system, but also a bridge for communication between musicians and composers, ensuring accurate reproduction of the music.

### SUMMARY

The embodiments of the present disclosure provide a music stand. The music stand includes a sheet music board and a support frame. The support frame includes an adjusting component with at least one degree of freedom. The sheet music board is connected to the adjusting component; and the adjusting component is configured to adjust an angle of the sheet music board with respect to the support frame.

### BRIEF DESCRIPTION OF THE DRAWINGS

The description and drawings that constitute part of the present disclosure are provided for a further understanding of the present disclosure. The illustrative embodiments and their descriptions are provided for explanation but do not constitute improper limitations on the present disclosure.

FIG. 1 is a schematic structural view of a music stand according to some embodiments.

FIG. 2 is a schematic structural view of an adjusting component according to an embodiment.

FIG. 3 is a cross-sectional structural view of the adjusting component illustrated in FIG. 2.

FIG. 4 is an exploded schematic view of an adjusting component according to another embodiment.

FIG. 5 is a schematic structural view of the adjusting component with a ball joint mounted illustrated in FIG. 4.

FIG. 6 is a cross-sectional structural view of the adjusting component illustrated in FIG. 5.

FIG. 7 is an exploded schematic view of the adjusting component illustrated in FIG. 5.

FIG. 8 is an exploded schematic view of the adjusting component with a columnar connecting rod mounted illustrated in FIG. 4.

FIG. 9 is a cross-sectional structural view of the adjusting component illustrated in FIG. 8 in an assembled state.

FIG. 10 is a schematic view structural view of a music stand including a first fixing structure according to some embodiments.

FIG. 11 is a schematic structural view of a music stand including a second fixing structure according to some embodiments.

FIG. 12 is an exploded schematic view of a second fixing structure according to some embodiments.

FIG. 13 shows a fixing assembly and a telescopic assembly according to some embodiments.

FIG. 14 shows a fixing assembly and a flexible rod according to some embodiments.

FIG. 15 is a schematic structural view of a third fixing assembly according to some embodiments.

FIG. 16 is a schematic structural view of a fourth fixing assembly according to some embodiments.

FIG. 17 shows an implementation way of an adjustment assembly according to some embodiments.

FIG. 18 is a schematic structural view of a music stand with a rotating shaft according to some embodiments.

FIG. 19 is a schematic structural view of a sheet music board according to some embodiments.

FIG. 20 is a schematic structural view of a sheet music board with loose-leaf and sheet music mounted according to some embodiments.

FIG. 21 is a schematic structural view of loose-leaf and sheet music according to some embodiments.

FIG. 22 is a partial enlarged schematic view of a sheet music board according to some embodiments.

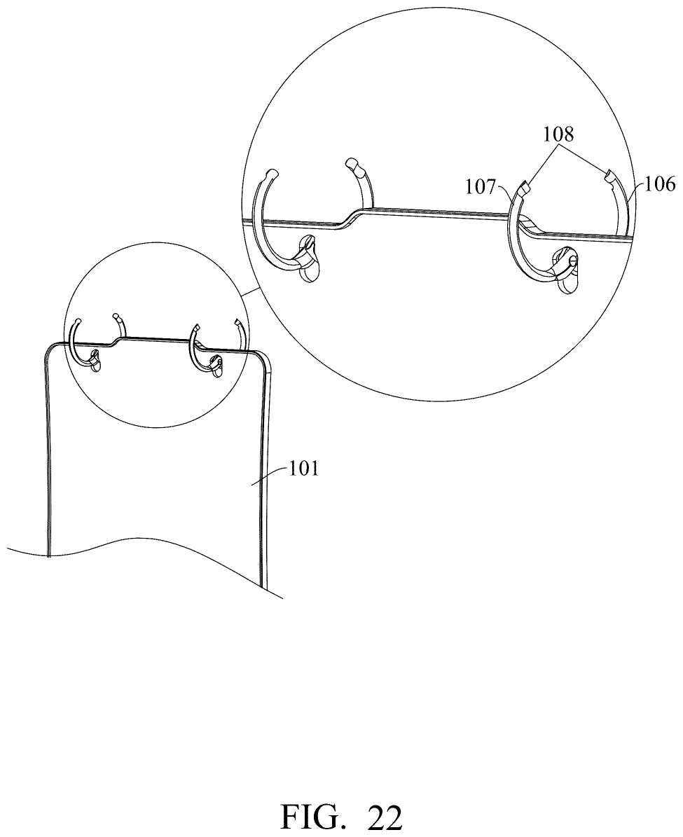

### DETAILED WAY

The present disclosure will be described in detail below with reference to the accompanying drawings and in conjunction with various embodiments. Each example is provided to explain but not limit the present disclosure. In fact, it will be clear to those of ordinary skill that modifications and variations may be made without departing from the scope or spirit of the present disclosure. For example, a feature shown or described as part of one embodiment may be used according to another embodiment to produce yet another embodiment. Therefore, it is intended that the present disclosure includes such modifications and variations within the scope of the appended claims and their equivalents.

In the description of the present disclosure, the terms “longitudinal”, “lateral”, “upper”, “lower”, “front”, “back”, “left”, “right”, “vertical”, “horizontal”, “top”, “bottom” and the like indicate the orientational or positional relationship based on the orientational or positional relationship illustrated in the drawings, which is only for the convenience of describing and does not require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may also be a wired electrical connection, a radio connection, or a wireless signal connection. For those of ordinary skill in the art, the specific meanings of the above terms may be understood according to the specific circumstances.

One or more examples of the present disclosure are illustrated in the attached drawings. Numbers and letter signs are used in the detailed description to refer to features in the drawings. Similar signs in the drawings and descriptions have been configured to refer to similar parts of the present disclosure. As used herein, the terms “first”, “second” and “third” are used interchangeably to distinguish one component from another and are not intended to indicate the position or importance of individual components.

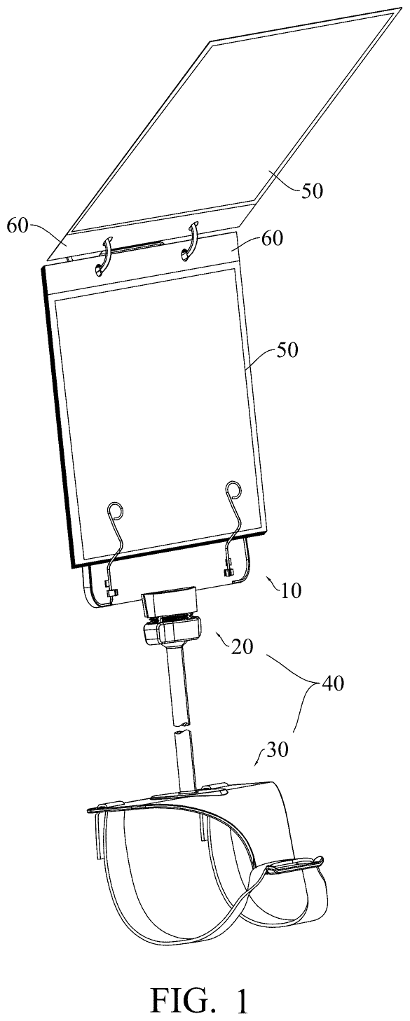

As illustrated in FIG. 1, an embodiment of the present disclosure provides a music stand, which includes a sheet music board 10 and a support frame 40. The support frame 40 includes an adjusting component 20 with at least one degree of freedom, and the adjusting component 20 is arranged on a first end of the support frame 40. The sheet music board 10 is connected to the adjusting component 20, and the viewing angle of the sheet music board 10 is adjusted by the adjusting component 20.

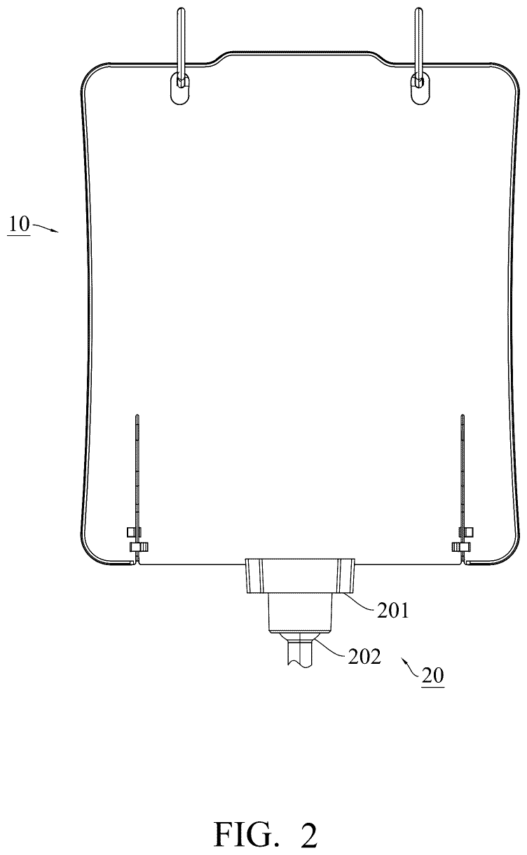

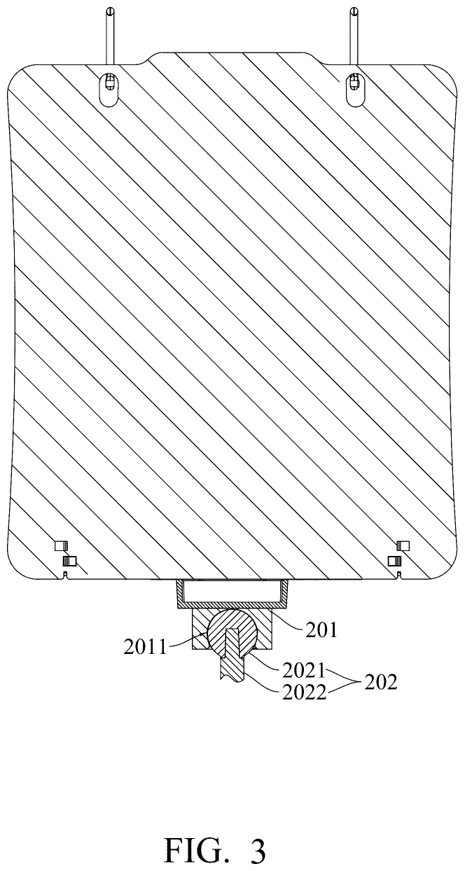

As illustrated in FIG. 2 and FIG. 3, in some embodiments, the adjusting component 20 includes a first base 201 and a ball joint 202. The ball joint 202 includes a connecting rod 2022 and a ball 2021 arranged on a first end of the connecting rod 2022. A first end of the first base 201 is defined with a cavity 2011, and the ball 2021 is rotatably mounted in the cavity 2011 of the first base 201. A second end of the connecting rod 2022 is connected to a first end of the support frame 40, and a second end of the first base is connected to the sheet music board 10.

In some embodiments, the ball 2021 of the ball joint 202 is interference-fitted with an inner wall of the cavity 2011 of the first base 201, such that there is a damping effect when the ball 2021 is rotating in the cavity 2011.

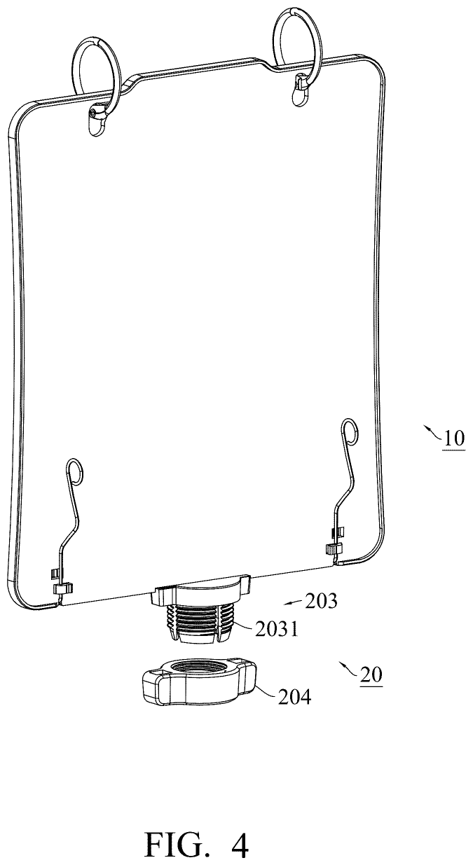

As illustrated in FIG. 4, in some embodiments, the adjusting component 20 includes a second base 203, a first end of the second base 203 is provided with a tubular inner sleeve 2031, and a second end of the second base 203 is fixedly connected to the sheet music board 10. The inner sleeve 2031 is defined with a cavity, an outer wall of the inner sleeve 2031 is provided with an external thread, and an outer wall of an end of the inner sleeve 2031 is defined with an opening along its axial direction. An adjusting nut 204 is mounted on an outer side of the inner sleeve 2031, and the adjusting nut 204 is threadedly connected to the inner sleeve 2031. In the process of tightening the adjusting nut 204 with the inner sleeve 2031, the opening of the inner sleeve 2031 is gradually closed, such that the inner diameter of the port at the second end of the inner sleeve 2031 gradually decreases, and the volume of the cavity decreases accordingly. Alternatively, the inner diameter of the port at the second end of the inner sleeve 2031 gradually increases, and the volume of the cavity increases accordingly.

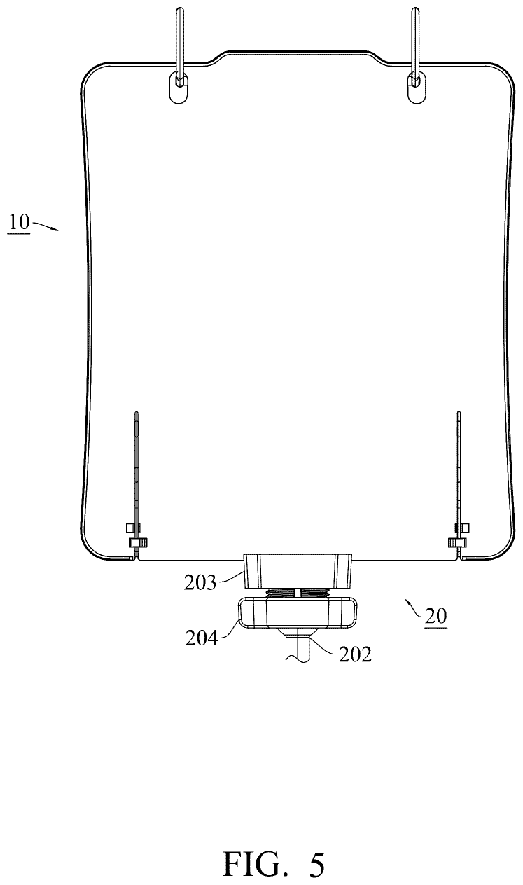

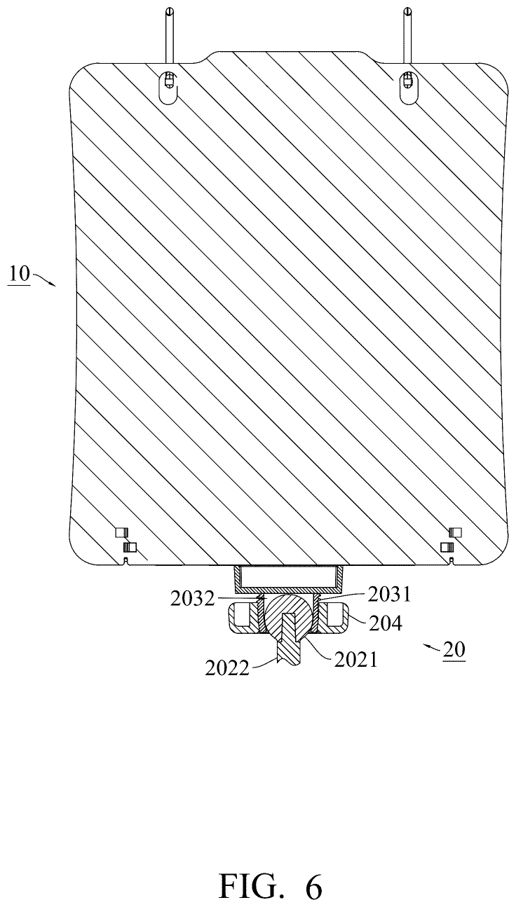

As illustrated in FIG. 5 and FIG. 6, in some embodiments, the inner sleeve 2031 is equipped with a rotatable ball joint 202, a ball 2021 of the ball joint 202 is arranged in the cavity 2032, and a connecting rod 2022 of the ball joint 202 is connected to a first end of the support frame 40. The sheet music board 10 and the support frame 40 may be detachably connected by adjusting the nut 204. The tightness of the ball joint 202 in the cavity 2032 may also be controlled, to adjust the angle of the sheet music board 10 with respect to the support frame 40 and lock the sheet music board 10 at the above angle.

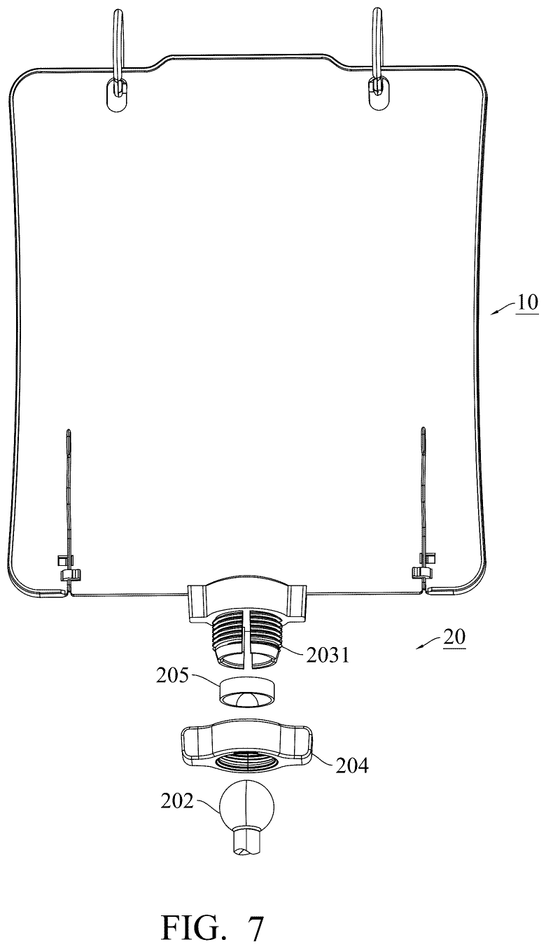

As illustrated in FIG. 7, in some embodiments, a bowl 205 is provided on a bottom of the cavity 2032, and the bowl 205 is defined with a spherical inner concave surface, and the spherical inner concave surface faces the ball 2021 of the ball joint 202. The bowl 205 may allow the ball 2021 of the ball joint 202 rotate more smoothly in the inner sleeve 2031.

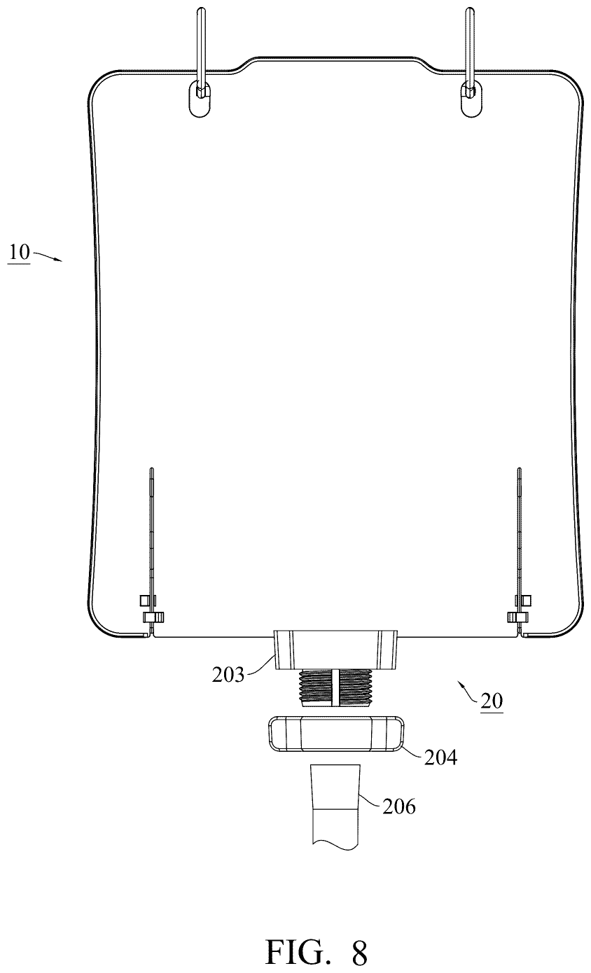

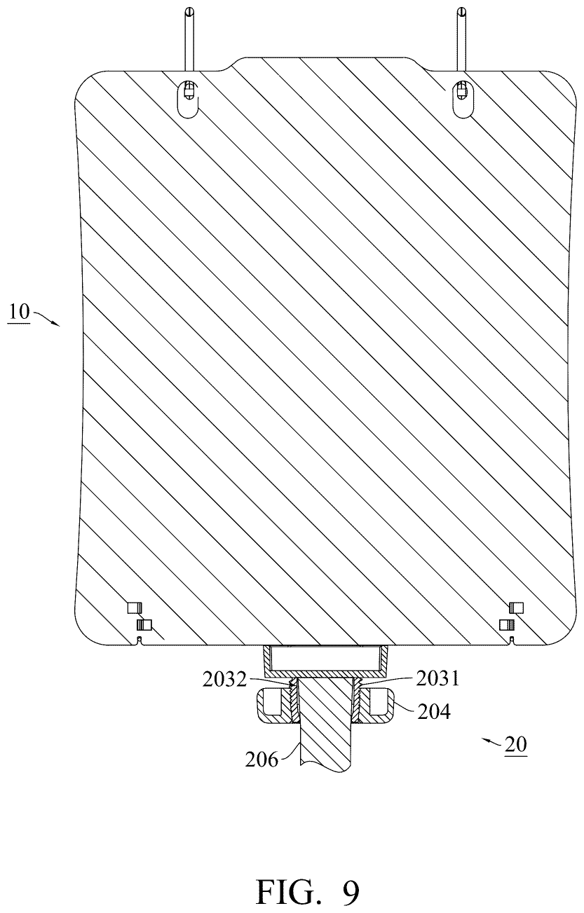

As illustrated in FIG. 8 and FIG. 9, in some embodiments, the inner sleeve 2031 is mounted with a rotatable columnar connecting rod 206. A first end of the columnar connecting rod 206 is provided inside the cavity 2032 and may rotate relative to the inner sleeve 2031. A second end of the columnar connecting rod 206 is connected to the support frame 40. The sheet music board 10 and the support frame 40 may be detachably connected by adjusting the nut 204. The tightness of the first end of the columnar connecting rod 206 in the cavity 2032 may also be controlled, to adjust the angle of the sheet music board 10 with respect to the support frame 40 and lock the sheet music board 10 at the above angle.

Different structural schemes of the support frame 40 may be selected in different application scenarios.

In some embodiments, the support frame 40 includes a support rod, a first end of the support rod is connected to the adjusting component 20, and a second end of the support rod is provided with a base. In an environment such as a concert hall, the support rod may be selectively placed on the ground, and the performer may adjust the optimal angle of the sheet music board 10 based on a required viewing angle.

In addition, in some traveling performances, the support frame 40 needs to be mounted on a moving object or structure. Therefore, in some embodiments, the support frame 40 includes a fixing assembly 30, and the fixing assembly 30 is arranged on the second end of the support frame 40.

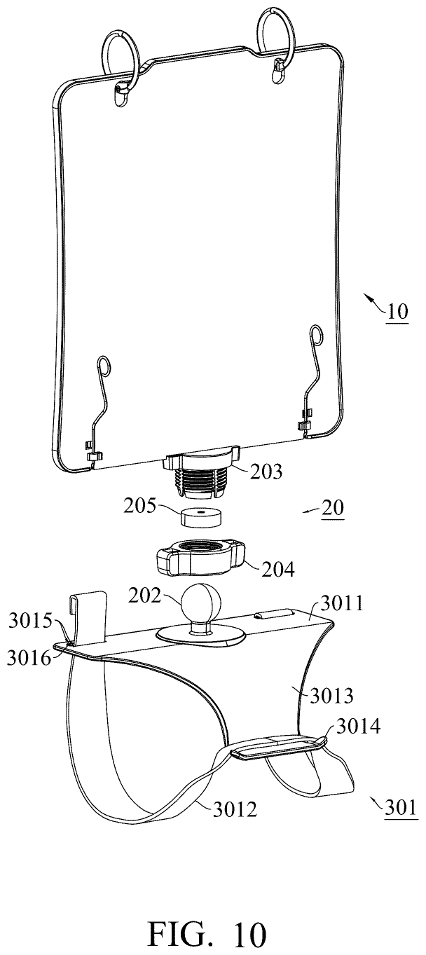

As illustrated in FIG. 10, in some embodiments, the fixing assembly 30 includes a first fixing structure 301 which includes a fixing plate 3011 and a fastening belt 3012. A first side of the fixing plate 3011 is provided with a bending portion, and a second side is defined with two strip-shaped holes 2015. The second end of the connecting rod 2022 of the ball joint 202 is fixedly mounted on the fixing plate 3011. A horizontal plate 3016 is provided within the strip-shaped hole 3015, and the horizontal plate 3016 divides the strip-shaped hole 2015 into two independent holes. An end of the fastening belt 3012 may pass through one of the holes and then pass through the other hole to achieve the fixed installation between the fastening belt 3012 and the strip-shaped holes 3015. The two strip-shaped holes 3015 are arranged symmetrically with respect to the center of the second side of the fixing plate 3011. An end of the bending portion is upwardly bent and hook shaped. A first end of the fixing belt is fixedly mounted through one of the strip-shaped holes 3015, and a second end of the fixing belt is fixedly mounted through the other strip-shaped hole 3015 after passing through an upper part of the bending portion.

In some embodiments, the above-mentioned hook-shaped end is further provided with a flange 3014 that is further bent upward to reduce the risk of the fastening belt 3012 falling off the bending portion.

In some embodiments, the first fixing structure 301 may be fixedly placed on the arm of a performer, and the performer may change the angle of the adjusting component 20 as needed, thereby adjusting the angle of the sheet music board 10 with respect to the adjusting component 20.

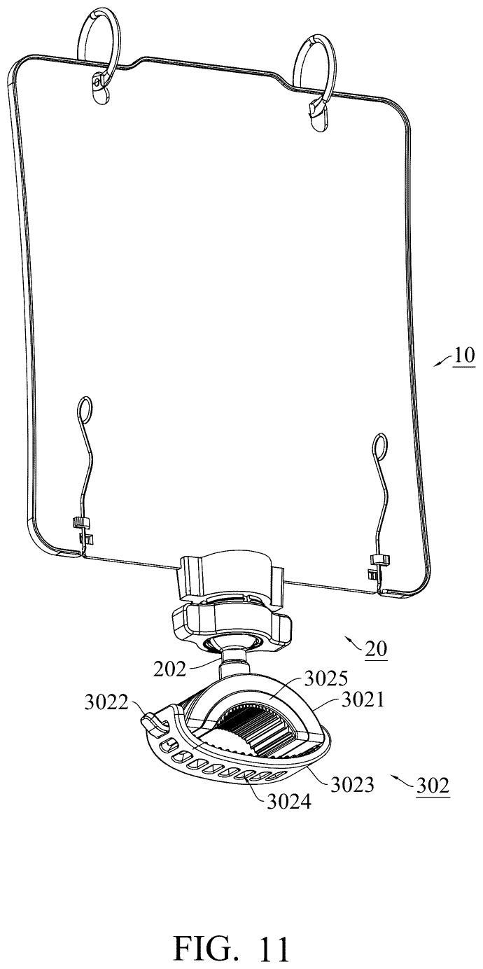

As illustrated in FIG. 11, in some embodiments, the fixing assembly 30 includes a second fixing structure 302. The second fixing structure 302 includes an arc plate 3021 and a locking belt 3023. The second end of the connecting rod 2022 of the ball joint 202 is fixedly mounted on an outer arc surface of the arc plate 3021. A first end of the arc plate 3021 is connected to a first end of the locking belt 3023, and a second end of the arc plate 3021 is provided with a locking buckle 3022. The locking belt 3023 is defined with a plurality of locking holes 3024, and the plurality of locking holes 3024 are distributed along the longitudinal direction of the locking belt 3023. The second fixing structure 302 adjusts the fixation strength of the locking belt 3023 by engaging the locking buckle 3022 with different locking holes 3024.

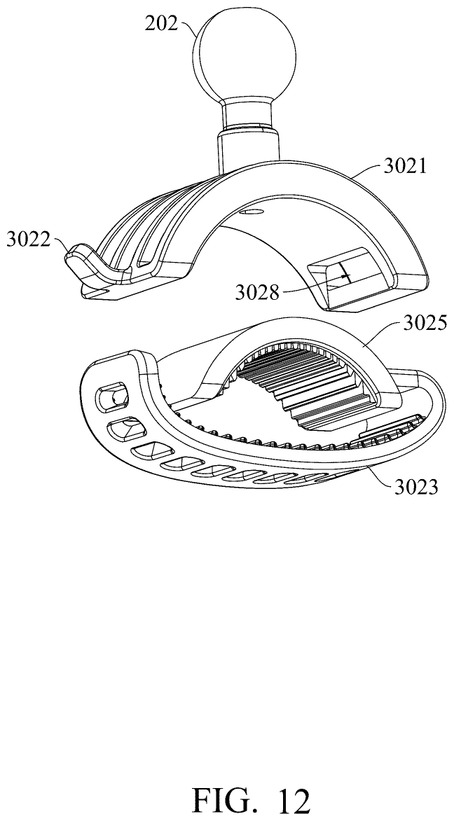

In some embodiments, an inner arc surface of the arc plate 3021 is provided with a gasket 3025. The gasket 3025 may provide a buffer for fixing and may also increase the friction force during fixing. In some embodiments, as illustrated in FIG. 12, the first end of the arc plate 3021 is provided with a through hole 102. A first end of the gasket 3025 is connected to the first end of the locking belt 3023, and the second end of the locking belt 3023 may pass through the through hole 102.

In some application scenarios, the second fixing structure 302 may be fixedly mounted on the tubular instrument, and the performer may change the angle of the adjusting component 20 as needed, thereby adjusting the angle of the sheet music board 10 with respect to the adjusting component 20.

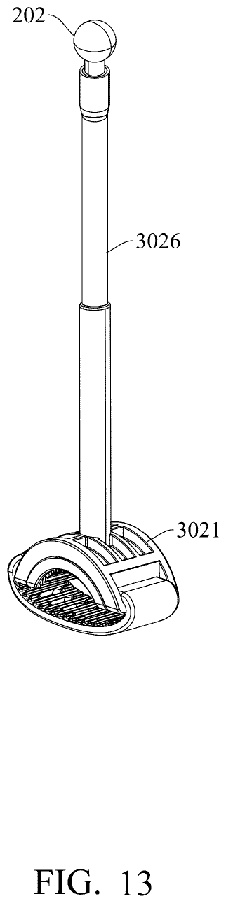

As illustrated in FIG. 13, in some embodiments, the second end of the connecting rod 2022 of the ball joint 202 may be optionally provided with a telescopic structure 3026 with adjustable length. A first end of the telescopic structure 3026 is connected to the outer arc surface of the arc plate 3021, and a second end is connected to the second end of the connecting rod 2022 of the ball joint 202.

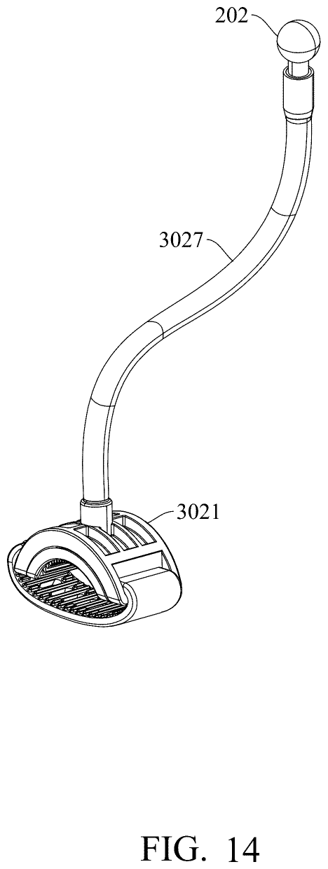

As illustrated in FIG. 14, in some embodiments, the second end of the connecting rod 2022 of the ball joint 202 may be optionally provided with a bendable flexible rod 3027. A first end of the flexible rod 3027 is connected to the outer arc surface of the arc plate 3021, and a second end is connected to the second end of the connecting rod 2022 of the ball joint 202.

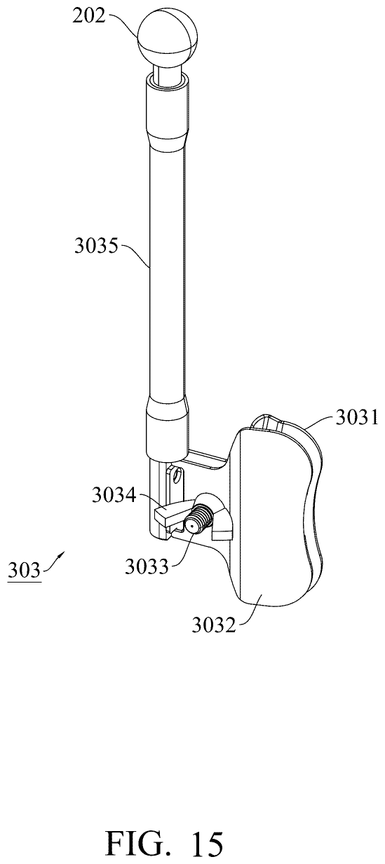

As illustrated in FIG. 15, in some embodiments, the fixing assembly 30 includes a third fixing structure 303, and the third fixing structure 303 includes a first clamping plate 3031 and a second clamping plate 3032. The second end of the connecting rod 2022 of the ball joint 202 is connected to a first end of the first clamping plate 3031 through the flexible rod 3027. A bolt 3033 is provided on one side of the first clamping plate 3031 proximate to its first end, and a first end of the bolt 3033 is fixedly connected to the first clamping plate 3031. The second clamping plate 3032 is defined with a through hole 102, and the through hole 102 is proximate to the first end of the second clamping plate 3032. When the first clamping plate 3031 is being assembled with the second clamping plate 3032, two ends of the first clamping plate 3031 are correspondingly assembled with two ends of the second clamping plate 3032, the bolt 3033 may pass through the through hole 102, and then a nut 3034 may be mounted on a second end of the bolt 3033. The nut 3034 is configured to adjust the distance between the second end of the first clamping plate 3031 and the second end of the second clamping plate 3032, thereby controlling the clamping force of the third fixing structure 303.

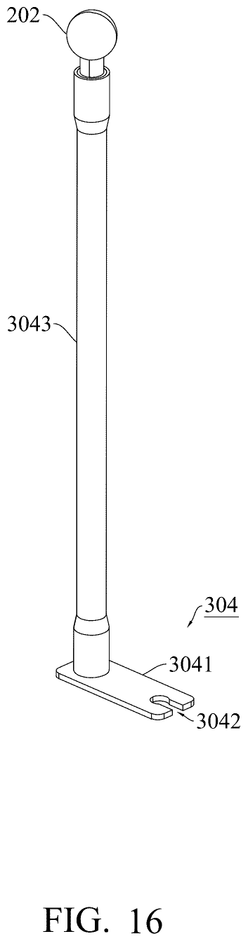

As illustrated in FIG. 16, in some embodiments, the fixing assembly 30 includes a fourth fixing structure 304, and the fourth fixing structure 304 includes an interlocking plate 3041, and a first end of the interlocking plate 3041 is defined with an interlocking interface 3042. The second end of the connecting rod 2022 of the ball joint 202 is connected to a second end of the interlocking plate 3041 through the flexible rod 3027. The fourth fixing structure 304 is clipped with the carrier through the interlocking interface 3042.

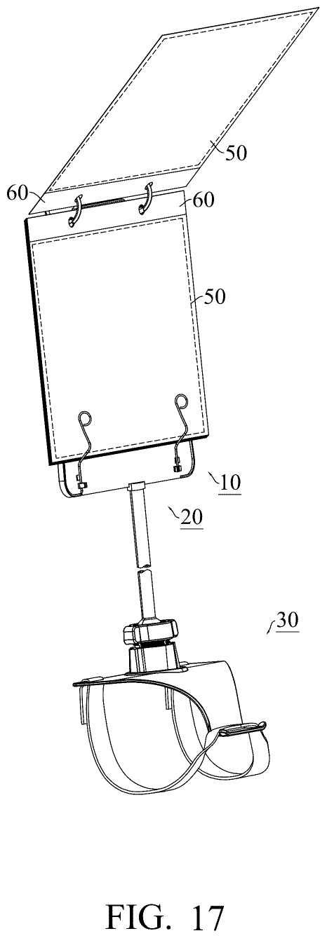

As illustrated in FIG. 17, in some embodiments, the adjusting component 20 includes a third base and a ball joint 202, the third base is defined with a cavity, and a ball 2021 of the ball joint 202 is rotatably mounted in the cavity. The third base is connected to the fixing assembly 30, and the connecting rod 2022 of the ball joint 202 is connected to the sheet music board 10.

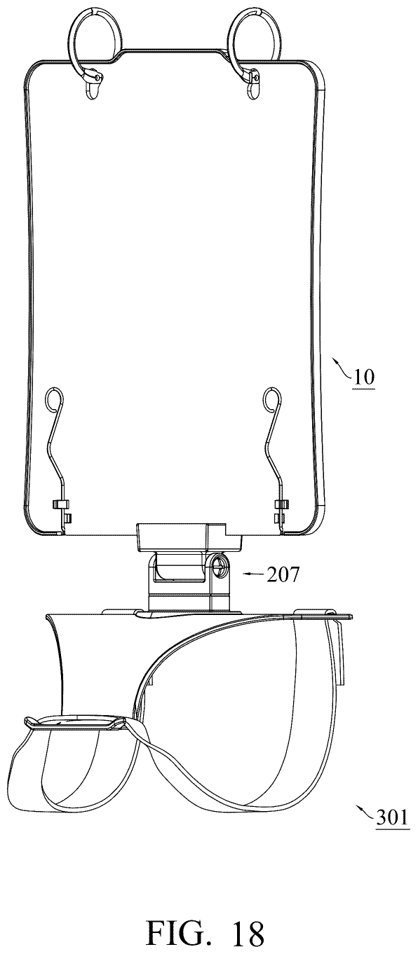

As illustrated in FIG. 18, in some embodiments, the adjusting component 20 may be implemented by a rotating shaft 207. A top of the rotating shaft 207 may adjust the horizontal angle, and a bottom of the rotating shaft 207 may rotate in the horizontal direction.

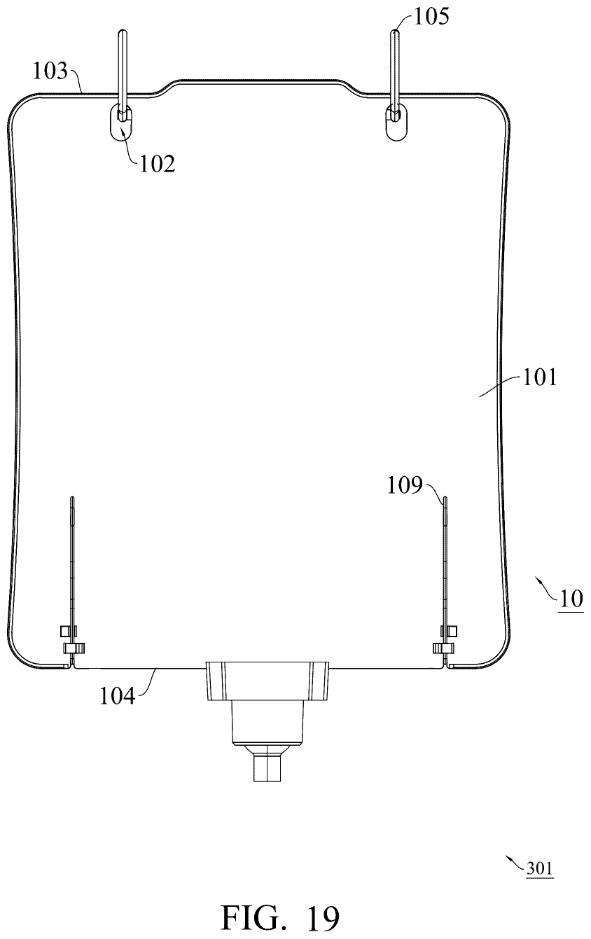

As illustrated in FIG. 19, the sheet music board 10 includes a panel 101, the panel 101 includes a first side 103 and a second side 104, and the first side 103 is arranged opposite to the second side 104. The panel 101 is defined with two through holes 102, both of which are proximate to the first side 103 and are arranged separately along the longitudinal direction of the first side 103. A page ring 105 that may be selectively to be opened is mounted through each through hole 102. The second side 104 of the panel 101 is connected to the adjusting component 20.

In some embodiments, the sheet music 50 is defined with a hole for the page ring 105 to pass through, and the sheet music 50 may be selectively placed on the panel 101 through the page ring 105.

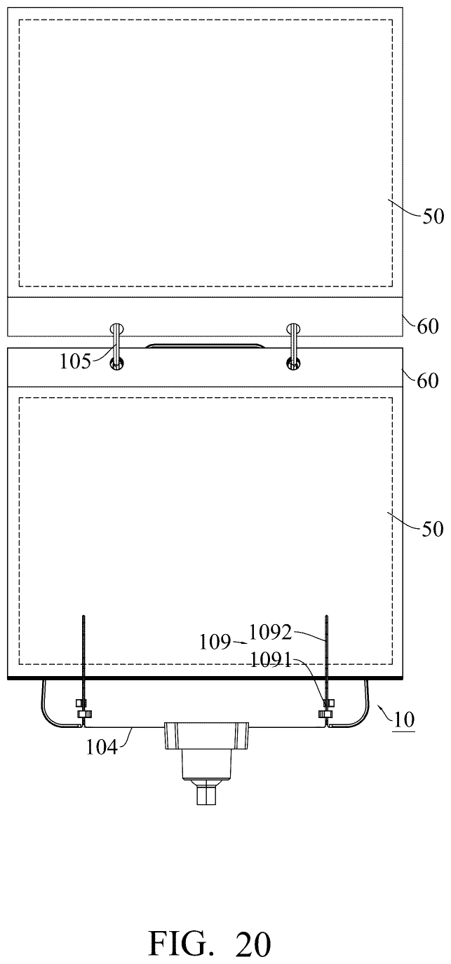

As illustrated in FIG. 19 and FIG. 20, in some embodiments, the sheet music board 10 also includes a loose-leaf 60, the loose-leaf 60 is defined with a hole for the page ring 105 to pass through, and the loose-leaf 60 may be selectively placed on the panel 101 through the page ring 105. The sheet music 50 may be placed in or taken out of the loose-leaf 60, and the sheet music 50 is restricted on the panel 101 through the loose-leaf 60.

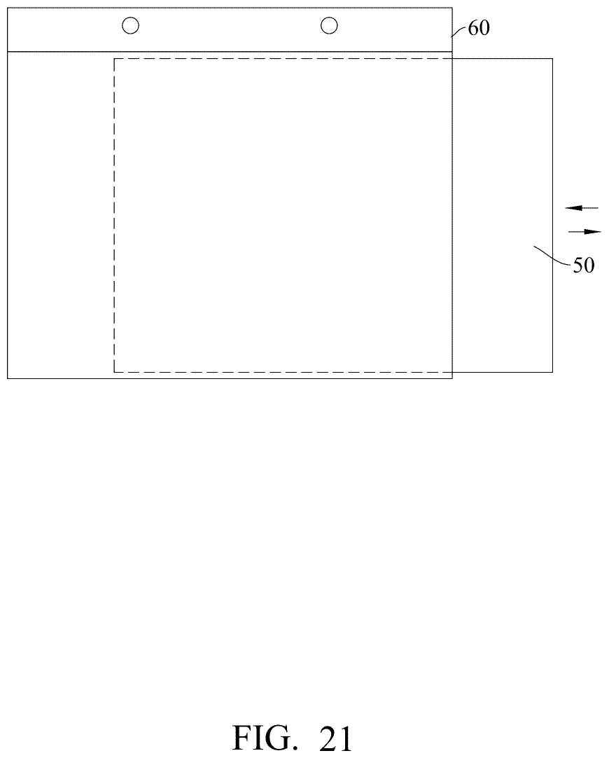

As illustrated in FIG. 21, in some embodiments, the page ring 105 includes a first half ring 106 and a second half ring 107. A first end of the first half ring 106 and a first end of the second half ring 107 are rotatably connected, and a second end of the first half ring 106 and a second end of the second half ring 107 may be selectively opened or closed. In some embodiments, the second end of the first half ring 106 and the second end of the second half ring 107 are provided with a lock 108 that may be locked to each other.

As illustrated in FIG. 19 and FIG. 20, in some embodiments, the panel 101 is provided with at least one page clip 109 for locking the sheet music 50 on the panel 101. In some embodiments, the page clip 109 is a stripped structure with elasticity, a first end of the page clip 109 is locked to the panel 101, and a second end of the page clip 109 may be selectively proximate to or away from the surface of the panel 101.

Compared with the related art, in the embodiments of the present disclosure, the music stand is provided with an adjusting component for adjusting the sheet music board. The adjusting component has adjustment capability of at least one degree of freedom, and the performer mya adjust the viewing angle of the sheet music board as needed. In addition, in some embodiments, the adjusting component includes an inner sleeve and an adjusting nut. The adjusting nut may realize a detachable connection between the sheet music board and the support frame, and the tightness of the inner sleeve may also be controlled to facilitate the adjustment of the angle of the sheet music board with respect to the support frame. Third, the music stand may also be adapted to different fixing assemblies according to different musical instruments, so that the performer can perform more freely. Especially in some traveling performances, the music stand may be fixed on the instrument or the performer's arm.

The above description is only some embodiments of the present disclosure and is not intended to limit the present disclosure. For those of ordinary skill in the art, the present disclosure may have various modifications and variations. Any modification, equivalent replacement, improvement, etc. made within the spirit and principle of the present disclosure shall be included in the protection scope of the present disclosure.

What is claimed is:

1. A music stand, comprising:
a sheet music board and a support frame;
wherein the support frame comprises an adjusting component with at least one degree of freedom;
the sheet music board is connected to the adjusting component; and
the adjusting component is configured to adjust an angle of the sheet music board with respect to the support frame.

2. The music stand according to claim 1, wherein the adjusting component comprises a first accessory and a second accessory; and
a first end of the first accessory is rotatably connected to a first end of the second accessory.

3. The music stand according to claim 2,
wherein the first accessory is defined with a cavity; and
the first end of the second accessory is rotatably mounted in the cavity.

4. The music stand according to claim 3, wherein the first accessory comprises:
a tubular inner sleeve, the inner sleeve is defined with the cavity, an outer wall of the inner sleeve is provided with an external thread, and an outer wall of an end of the inner sleeve is defined with an opening along its axial direction; and
an adjusting nut, provided with an internal thread;
wherein the adjusting nut is threadedly connected with the inner sleeve, and the opening and closing of a port of the inner sleeve is controlled by rotating the adjusting nut to different directions.

5. The music stand according to claim 3, wherein the second accessory comprises a ball joint, the ball joint comprises a connecting rod and a ball disposed on a first end of the connecting rod, and the ball is capable of being mounted in the cavity.

6. The music stand according to claim 1, wherein the support frame also comprises a fixing assembly, a first end of the fixing assembly is connected to the adjusting component, and a second end of the fixing assembly is connected to a carrier for carrying the music stand.

7. The music stand according to claim 6, wherein the fixing assembly comprises a fixing plate and a fastening belt, a first end of the fixing plate is provided with a bending portion and a second end of the fixing plate is defined with at least one strip-shaped hole; the fastening belt is limited between the strip-shaped hole and the bending portion; and
the adjusting component is connected to the fixing plate.

8. The music stand according to claim 7, wherein an end of the bending portion is a hook-shaped structure bent upward.

9. The music stand according to claim 8, wherein the hook-shaped end is provided with an upwardly bent flange.

10. The music stand according to claim 6, wherein the fixing assembly comprises an arc plate and a locking belt; a first end of the arc plate is connected to a first end of the locking belt, a second end of the arc plate is provided with a locking buckle; the locking belt is defined with a plurality of locking holes; the fixing assembly adjusts the tightness of the locking belt through the locking buckle engaging with different locking holes; and
the adjusting assembly is connected to an outer arc surface of the arc plate.

11. The music stand according to claim 10, wherein an inner arc surface of the arc plate is provided with a gasket.

12. The music stand according to claim 11, wherein the first end of the arc plate is defined with a through hole; and
a first end of the gasket is connected to the first end of the locking belt, and a second end of the locking belt is capable of passing through the through hole.

13. The music stand according to claim 6, wherein the fixing assembly comprises a first clamping plate, a second clamping plate, a bolt and a nut;
the first clamping plate is fixedly connected to a first end of the bolt, and the nut is mounted on a second end of the bolt; the second clamping plate is defined with a through hole configured for the bolt to pass through; the second clamping plate is mounted on the bolt through the through hole and is limited between the first clamping plate and the nut; and
the nut is configured to adjust a distance between the first clamping plate and the second clamping plate and control the clamping force of the fixing assembly.

14. The music stand according to claim 6, wherein the fixing assembly comprises an interlocking plate, a first end of the interlocking plate is defined with a interlocking interface, and the interlocking interface is configured for the carrier to snap in; and
the adjusting component is connected to a second end of the interlocking plate.

15. The music stand according to claim 1, wherein one end of the adjusting component is provided with a telescopic structure with adjustable length; or
one end of the adjusting component is provided with a flexible rod.

16. The music stand according to claim 1, wherein the sheet music board has sheet music placed thereon, and the sheet music board comprises:
a first side;
a second side, arranged opposite to the first side;
at least one through hole, defined proximate to the first side of the sheet music board; and
a page ring, mounted through the through hole, wherein the page ring is configured to limit the sheet music on the sheet music board.

17. The music stand according to claim 16, wherein the page ring is capable of being opened or closed.

18. The music stand according to claim 16, wherein the sheet music board also comprises a loose-leaf, and the sheet music is capable of being placed in or taken out of the loose-leaf; and
the page ring is configured to be selectively opened, and the loose-leaf is mounted through the page ring.
